(19) United States
(12) Patent Application Publication
(10) Pub. No.: US 2026/0351709 A1
(43) Pub. Date: Nov. 5, 2026

(54) WEAPONIZED DRONE

(71) Applicant: Raytheon Company, Arlington, VA (US)

(72) Inventor: Jonathan Giddens, Anna, TX (US)

(21) Appl. No.: 19/195,332

(22) Filed: Apr. 30, 2025

(51) Int. Cl. H01M 10/63; B64U 50/30; B64U 101/15

(52) U.S. Cl. CPC H01M 10/63; B64U 50/30; B64U 2101/15; H01M 2220/20

(57) ABSTRACT

A weaponized drone comprises a flight battery, a battery-detonation element and control circuitry. The flight battery may be configured to generate current for propulsion of the drone. The control circuitry may be configured to receive a trigger signal and configure the battery-detonation element to cause the flight battery of the drone to overheat, catch fire or explode by at least one of application of a short circuit across the battery and puncturing of the battery.

### TECHNICAL FIELD

Some embodiments pertain to unmanned aerial vehicles (UAVs) or unmanned aircraft system (UASs), including drones. Some embodiments pertain to battery-powered drones.

### BACKGROUND

One issue with drones, particularly smaller and lighter-weight battery powered drones, is their ability to carry a payload. The payload capacity of small battery-powered drones represents a key engineering challenge. Smaller drones may have less lifting power relative to their own weight. As drone size decreases, this ratio becomes increasingly unfavorable. Furthermore, current drone batteries offer limited energy per unit weight creating a direct tradeoff between flight time and payload capacity. In addition, smaller drones may have smaller propellers or rotors which generate less thrust per watt of power consumed.

Militaries across the world are using more small drone technology to perform actions. Recently militaries have been pushing to add munitions to these drones to make them lethal. Payload capacity is particularly an issue for these weaponized drones (i.e., drones that are equipped with weapons or payloads designed to cause harm or damage) since such drones may need to travel over greater distances.

Thus, there are general needs for drones, particularly weaponized drones, which do not need to carry payloads. Thus, there are also needs for drones, particularly weaponized drones, which are lighter, can travel over greater distances and/or have an increased flight time.

### BRIEF DESCRIPTION OF THE DRAWINGS

FIG. 1 illustrates an example of drone, in accordance with some embodiments.

FIG. 2 illustrates a simplified functional block diagram of a weaponized drone, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments disclosed here are directed to a weaponized drone that uses its flight battery as an explosive device. These embodiments reduce the payload requirements and may allow a drone to travel over greater distances and increase its flight time. Furthermore, weaponized drones that use the flight battery as an explosive device may be able to have a reduced size and lower detection level.

Some embodiments are directed to a weaponized drone comprising a flight battery, a battery-detonation element and control circuitry. The flight battery may be configured to generate current for propulsion of the drone. The control circuitry may be configured to receive a trigger signal and configure the battery-detonation element to cause the flight battery of the drone to overheat, catch fire or explode by at least one of application of a short circuit across the battery and puncturing of the battery. These embodiments, as well as others, are discussed in more detail below.

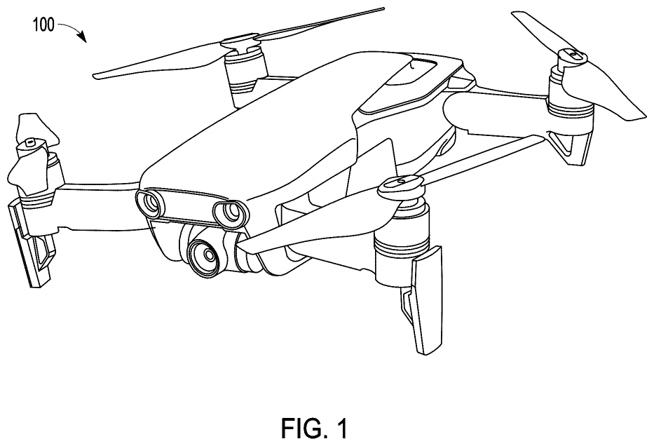

FIG. 1 illustrates an example of drone, in accordance with some embodiments. Drone 100 may be an unmanned aerial vehicle (UAV) and when operating, may be controlled by a remotely-located operator and/or may be autonomous. Drone 100 may include various active and passive circuitry, including communication antennas, as well as structural elements. Drone 100 may be configured as a weaponized drone. In these embodiments, drone 100 may be configured to cause its flight battery to overheat, catch fire and/or explode by application of a short across the battery and/or puncturing of the battery. These embodiments are described in more detail below.

In these embodiments, the drone 100 may be an unmanned aerial vehicle (UAV) or unmanned aircraft system (UAS) (e.g., an aircraft with no human pilot, crew, or passengers onboard) that is controlled remotely or is autonomous. In these embodiments, the drone 100 may be a small drone weighing less than 9.1 kg (20 lbs.), although the scope of the embodiments are not limited in this respect. In these embodiments, the drone 100 may be a battery-powered aircraft in which the battery may be configured to provide current to one or more electric motors to spin propellers or rotors to create thrust.

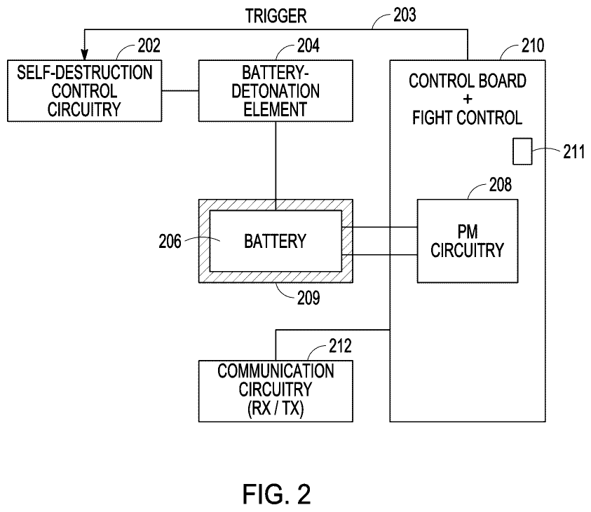

FIG. 2 illustrates a simplified functional block diagram of a weaponized drone, in accordance with some embodiments. In accordance with embodiments, weaponized drone 100 (FIG. 1) may comprise control circuitry 202 and a battery-detonation element 204. In these embodiments, the control circuitry 202 may be configured to receive a trigger signal 203, and in response to the trigger signal 203, the control circuitry 202 may configure the battery-detonation element 204 to cause a battery 206 of the drone 100 to overheat, catch fire or explode by at least one of application of a short across the battery 206 and puncturing of the battery 206.

In some embodiments, the drone 100 may further comprise power-management circuitry 208 to monitor one or more parameters of the battery 206. The one or more parameters may include battery temperature, battery output voltage and battery output current. In these embodiments, the power-management circuitry 208 may regulate power consumption based on the monitored one or more parameters to ensure the battery 206 does not overheat, catch fire or explode during normal flight operation of the drone 100.

In some embodiments, in response to the trigger signal 203, the control circuitry 202 may configure the power-management circuitry 208 to refrain from regulating the power consumption to allow the battery-detonation element 204 to cause a battery 206 of the drone 100 to overheat, catch fire or explode.

In some embodiments, the battery 206 may be a Lithium-Ion type battery, a Lithium-Polymer (LiPo) battery, or a Potassium-ion (K-ion) battery although the scope of the embodiments is not limited in this respect.

In some embodiments, the battery 206 may comprise a thin magnesium casing 207. In these embodiments, the thin magnesium casing around the battery 206 allows the battery 206 to burn hotter (e.g., up to 3100 deg C or more.

In some embodiments, the drone 100 may further comprise an explosive element adjacent to the battery 206. The explosive element may be configured to be detonated by the battery overheating, catching fire or exploding. In these embodiments, the explosive element may be a charge may further aid in self-destruction of the drone 100.

In some embodiments, the battery-detonation element 204 may comprise a solenoid. In these embodiments, in response to the trigger signal 203, the control circuitry 202 may configure the battery-detonation element 204 to trigger the solenoid to apply the short circuit across the battery 206.

In some embodiments, the battery-detonation element 204 may comprise a solid-state relay (SSR). In these embodiments, in response to the trigger signal 203, the control circuitry 202 may configure the battery-detonation element 204 to trigger the SSR to apply the short circuit across the battery 206. In these embodiments, the SSR may be an SSR without trip protection to allow the SSR to generate a short circuit to short-out the battery 206 (e.g., without tripping an internal circuit breaker). In these embodiments, the SSR may be selected to handle sufficient current when the battery 206 is shorted (i.e., 12 A for 60 cell LiPo battery).

In these embodiments in which a direct short is placed across the battery 206, the wires connecting the battery 206 to the battery-detonation element 204 may be chosen to handle the high current generated by the short. In some embodiments, heavy gauge wire (e.g., 10-gauge or 12-gauge wire) may be used, although the scope of the embodiments is not limited in this respect. In some embodiments, any type of mechanical or electronic solenoid that can handle the current from a directly shorted battery may be suitable.

In some embodiments, the battery-detonation element 204 may comprise a puncturing solenoid. In these embodiments, in response to the trigger signal 203, the control circuitry 202 may configure the battery-detonation element 204 to cause the puncturing solenoid to puncture the battery 206 to cause the battery 206 to overheat, catch fire or explode. In some embodiments, the drone 100 may include both a shorting solenoid to apply the short across the battery 206 and a puncturing solenoid to puncture the battery 206 to help ensure that the battery 206 overheats, catches fire or explodes, although the scope of the embodiments is not limited in this respect.

In some embodiments, the puncturing solenoid may comprise a small explosive device (e.g., a squib) configured to be detonated by the trigger signal 203 and configured to cause a puncturing element (e.g., a rod or shaft) to puncture the battery 206.

In some embodiments, the trigger signal 203 may be generated in response to receiving a detonation or self-destruct signal from a remote device (e.g., by a drone operator). In some embodiments, the trigger signal 203 may be a self-destruct signal.

In some embodiments, the trigger signal 203 is generated in response to proximity detection of a target. In some embodiments, the trigger signal 203 may be generated when the drone lands. In some of these embodiments, the drone 100 may be configured to operate as part of a drone swarm in which many drones of the swarm will land together and may detonate together.

In some embodiments, the trigger signal 203 may be generated by a crash-detection circuit 211 of the drone 100 in response to an intentional crash by the drone 100 (e.g., into a target) or an unintentional crash (e.g., the drone 100 being shot down by an enemy combatant). In these embodiments, if the drone 100 is shot down, it may be desirable for the drone 100 to self-destruct, for example, to prevent an enemy combatant from obtaining the drone 100.

In some embodiments, the crash-detection circuit 211 may be configured to refrain from generating the trigger signal 203 in response a signal from a remote controller (e.g., to prevent destruction of the drone 100 in certain circumstances). The crash-detection circuit 211 may be part of the flight-control circuitry 202 210 of the drone 100.

In some embodiments, the trigger signal 203 may be generated in response to a powered shutdown of the drone 100. In these embodiments, if the drone 100 is captured by an enemy combatant, it may be desirable for the drone 100 to self-destruct, for example, to prevent an enemy combatant from obtaining the drone 100.

Some embodiments are directed to an apparatus for use in a drone 100 (FIG. 1). In these embodiments, the apparatus may comprise control circuitry 202; and a battery-detonation element 204 (FIG. 2). In these embodiments, the control circuitry 202 may be configured to receive a trigger signal 203 and configure the battery-detonation element 204 to cause a battery 206 of the drone 100 to overheat, catch fire or explode by at least one of application of a short across the battery 206 and puncturing of the battery 206. In some embodiments, the drone 100 may also include RF communication circuitry 212, which may be used to receive signals from a remote device or remote controller.

In some embodiments, a remote control may be used to engage the short circuiting of the drone's highly volatile battery to make the drone a weapon. In some embodiments, this may be achieved via an emergency shut-off for surveillance drones so that the drone would short circuit and self-destruct if intercepted. In some embodiments, by controlling the short circuit of the battery in the drone, many hundreds of drones may land over a designated zone and a short circuit event may be initiated causing an outbreak of rampant fires.

Conventional drones are used for a variety of things and are currently being outfitted with ballistics and other types of weaponized accessories which make them large, easier to detect, and very loud. In accordance with some embodiments, the drone 100 becomes weaponized by the shorting of the volatile battery. This allows the drone to be as small as you would like as even a Lithium or any other type of battery style as small as the one in your cell phone can cause major damage when shorted. Li-ion fires, for example, are extremely hot (1,300 °F) and conventional fire extinguishers do not work on them, so the effectiveness of the fire is substantial.

In some embodiments, a direct short solenoid may be deployable from a hand-set or it may be set up as a default to actuate upon drone failure such that that if a drone is detected by an enemy and they neutralize the drone, it can automatically trip the solenoid causing a fire to not only cause harm but to burn up the drone so that the enemy cannot backwards engineer or obtain any type of government information.

Although the apparatus illustrated in FIG. 2 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Some embodiments are directed to a method performed by control circuitry of a weaponized drone. In these embodiments, the method may include receiving a trigger signal, and in response to the trigger signal, the method may include configuring a battery-detonation element to cause a battery of the drone to overheat, catch fire or explode by at least one of application of a short across the battery and puncturing of the battery.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus for use in a drone, the apparatus comprising: control circuitry; power-management circuitry and a battery-detonation element,
wherein the control circuitry is configured to:
receive a trigger signal from a crash-detection circuit; and
wherein in response to the trigger signal, the control circuitry is to configure the battery-detonation element to cause a battery of the drone to overheat, catch fire or explode by at least one of application of a short across the battery and puncturing of the battery,
wherein the power-management circuitry is configured to:
monitor one or more parameters of the battery, the one or more parameters including battery temperature, battery output voltage and battery output current; and
regulate power consumption based on the one or more parameters to ensure the battery does not overheat, catch fire or explode during flight operation of the drone,
wherein in response to the trigger signal, the control circuitry is to configure the power-management circuitry to refrain from regulating the power consumption,
wherein the trigger signal is generated by the crash-detection circuit in response to an intentional or an unintentional crash,
wherein the crash-detection circuit is configured to refrain from generating the trigger signal in response a signal from a remote controller, and
wherein the battery is one of a Lithium-Ion type battery, a Lithium-Polymer (LiPo) battery, and a Potassium-ion (K-ion) battery.

2.-4. (canceled)

5. The apparatus of claim 1, wherein the battery comprises a magnesium casing.

6. The apparatus of claim 1, further comprising an explosive element adjacent to the battery, the explosive element configured to be detonated by the battery at least one of overheating, catching fire and exploding.

7. The apparatus of claim 1, wherein the battery-detonation element comprises a solenoid, wherein in response to the trigger signal, the control circuitry is to configure the battery-detonation element to trigger the solenoid to apply the short across the battery.

8. The apparatus of claim 1, wherein the battery-detonation element comprises a solid-state relay (SSR), wherein in response to the trigger signal, the control circuitry is to configure the battery-detonation element to trigger the SSR to apply the short across the battery.

9. The apparatus of claim 1, wherein the battery-detonation element comprises a puncturing solenoid, wherein in response to the trigger signal, the control circuitry is to configure the battery-detonation element to cause the puncturing solenoid to puncture the battery to cause the battery to overheat, catch fire or explode.

10. The apparatus of claim 9, wherein the puncturing solenoid comprises an explosive device configured to be detonated by the trigger signal and configured to cause a puncturing element to puncture the battery.

11. The apparatus of claim 1, wherein the trigger signal is generated in response to receiving a detonation signal from a remote device.

12. The apparatus of claim 1, wherein the trigger signal is generated in response to proximity detection of a target.

13.-14. (canceled)

15. The apparatus of claim 1, wherein the trigger signal is generated in response to a powered shutdown of the drone.

16. A weaponized drone comprising:
power-management circuitry
a flight battery configured to generate current for propulsion of the drone;
a battery-detonation element; and
control circuitry configured to receive a trigger signal from a crash-detection circuit and configure the battery-detonation element to cause the flight battery of the drone to overheat, catch fire or explode by at least one of application of a short circuit and puncturing,
wherein the power-management circuitry is configured to:
monitor one or more parameters of the flight battery, the one or more parameters including battery temperature, battery output voltage and battery output current; and
regulate power consumption based on the one or more parameters to ensure the flight battery does not overheat, catch fire or explode during flight operation of the drone,
wherein in response to the trigger signal, the control circuitry is to configure the power-management circuitry to refrain from regulating the power consumption,
wherein the trigger signal is generated by the crash-detection circuit in response to an intentional or an unintentional crash, and
wherein the crash-detection circuit is configured to refrain from generating the trigger signal in response a signal from a remote controller.

17. The weaponized drone of claim 16, wherein the battery-detonation element comprises a solenoid, wherein in response to the trigger signal, the control circuitry is to configure the battery-detonation element to trigger the solenoid to apply the short across the battery.

18. The weaponized drone of claim 16, wherein the battery-detonation element comprises a puncturing solenoid, wherein in response to the trigger signal, the control circuitry is to configure the battery-detonation element to cause the puncturing solenoid to puncture the battery to cause the battery to overheat, catch fire or explode.

19. The weaponized drone of claim 16, wherein the battery is one of a Lithium-Ion type battery, a Lithium-Polymer (LiPo) battery, and a Potassium-ion (K-ion) battery, and
wherein the battery comprises a magnesium casing.

20. A method performed by control circuitry of a weaponized drone, the method comprising:
receiving a trigger signal from a crash-detection circuit;
in response to the trigger signal, configuring a battery-detonation element to cause a battery of the drone to overheat, catch fire or explode by at least one of application of a short across the battery and puncturing of the battery;
configuring power-management circuitry to monitor one or more parameters of the battery, the one or more parameters including battery temperature, battery output voltage and battery output current; and
configuring the power-management circuitry to regulate power consumption based on the one or more parameters to ensure the battery does not overheat, catch fire or explode during flight operation of the drone; and
configuring the power-management circuitry to refrain from regulating the power consumption in response to the trigger signal,
wherein the trigger signal is generated by the crash-detection circuit in response to an intentional or an unintentional crash, and
wherein the crash-detection circuit is configured to refrain from generating the trigger signal in response a signal from a remote controller.
